(19) United States
(12) Patent Application Publication
(10) Pub. No.: US 2007/0277745 A1
(43) Pub. Date: Dec. 6, 2007

(54) ANIMAL CONTAINMENT SYSTEM

(76) Inventors: David L. Clemmons, Dunkirk, IN (US); James W. Wingate JR., Muncie, IN (US); Bryan W. Jennings, Muncie, IN (US); William S. Kerr, Muncie, IN (US); Thomas W. Swan, Yorktown, IN (US); Robert Dale, Yorktown, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/755,497

(22) Filed: May 30, 2007

Related U.S. Application Data
(60) Provisional application No. 60/803,668, filed on Jun. 1, 2006.

(51) Int. Cl. A01K 1/03

(52) U.S. Cl. 119/455; 119/472

(57) ABSTRACT

An animal containment system for use in housing animals, the animal containment system including a floor pan disposed in a first plane, first and second end walls, each said end wall oppositely disposed from each other and including a bottom edge and a top edge, a back wall including a bottom edge and a top edge, two doors, each including a bottom edge and a top edge, oppositely disposed from the back wall arranged to cover the open front portion of said animal containment system, a top panel oppositely disposed from the floor pan, a shelf disposed in between the floor pan and top panel, a wire ladder extending between the floor pan and said shelf, and a wheel base assembly comprising a base panel, four support tubes and at least four removable caster wheels.

### TECHNICAL FIELD

The present claimed technology relates generally to a steel-wire containment system, and more particularly to an easily configurable containment system adapted for containing small animals.

### BACKGROUND

This claimed technology relates generally to animal containment systems of the type used to retain animals such as pets and the like. For many people, the keeping of small animals as pets offers significant enjoyment and benefits. The maintenance of such pets often requires the provision of a cage or similar structure for purposes of housing the animal. Such containment systems must be adapted to provide a containment function as well as a safe and sanitary environment.

Maintenance of a sanitary environment is often difficult in such containment systems. Unsanitary conditions in such containment systems contribute to the likelihood that the animal may become infected with disease. Recognizing that animals will often relieve themselves in such containment systems, it is of great concern that such containment systems be adapted for ease in cleaning and maintenance to restrict the development of such disease conditions.

Throughout history, containment systems have adopted a very typical construction. Such structures have in the past included a floor and a plurality of upstanding walls mounted to that floor. The walls are generally joined to one another along their vertically oriented edges to define an enclosure having an interior area for receiving the animal. Such structures have many times included walls fabricated of a wire material that permits the animal to see outwardly from within the interior of the structure. Containment systems in the past have typically lacked suitable safety features. For instance, shelves are often positioned high in the containment system, causing injury to animals that should fall from a shelf.

Although past efforts in the animal containment system industry have yielded a number of alternative animal containment system constructions, there continues to exist a need for an easily configurable animal containment system that provides an easy and efficient means of maintaining a safe and sanitary condition in an individualized containment system. The present claimed technology addresses those needs.

### SUMMARY

The present claimed technology relates to a steel-wire containment system.

One object of the present claimed technology is to provide an easy and efficient means of maintaining a sanitary condition in an individualized containment system.

Further objects, features, and advantages will become apparent from a consideration of the following description and accompanying drawings.

### BRIEF DESCRIPTION OF THE DRAWINGS

FIG. 1 is a perspective view of a preferred embodiment of the present claimed technology, including an exploded view of the components of the preferred embodiment.

FIG. 2 is a perspective view of a second preferred embodiment of the present claimed technology, including an exploded view of the components of the second preferred embodiment.

FIG. 3 is a perspective view of a third preferred embodiment of the present claimed technology, including an exploded view of the components of the third preferred embodiment.

FIG. 4 is a perspective view of a wheel base assembly for use in connection with the different embodiments of the present claimed technology, including an exploded view of the components of the wheel base assembly.

FIG. 5A is a top view of a preferred embodiment of the containment system shelf weldment of the present claimed technology of FIG. 1.

FIG. 5B is a side view of a preferred embodiment of the containment system shelf weldment of the present claimed technology of FIG. 1.

FIG. 6A is a top view of a preferred embodiment of the cutout floor pan of the present claimed technology of FIG. 2.

FIG. 6B is a side view of a preferred embodiment of the cutout floor pan of the present claimed technology of FIG. 2.

FIG. 6C is a front view of a preferred embodiment of the cutout floor pan of the present claimed technology of FIG. 2.

FIG. 7A is a top view of a preferred embodiment of the wire ladder of the present claimed technology of FIG. 1.

FIG. 7B is a side view of a preferred embodiment of the wire ladder of the present claimed technology of FIG. 1.

### DESCRIPTION OF THE PREFERRED EMBODIMENT

For the purposes of promoting an understanding of the principles of the claimed technology, reference will now be made to the embodiments illustrated in the drawings and specific language will be used to describe the same. It will nevertheless be understood that no limitation of the scope of the claimed technology is thereby intended, such alterations and further modifications in the illustrated device, and such further applications of the principles of the claimed technology as illustrated therein being contemplated as would normally occur to one skilled in the art to which the claimed technology relates.

This claimed technology is intended to provide an easy and efficient means of maintaining a safe and sanitary condition in an individualized containment system.

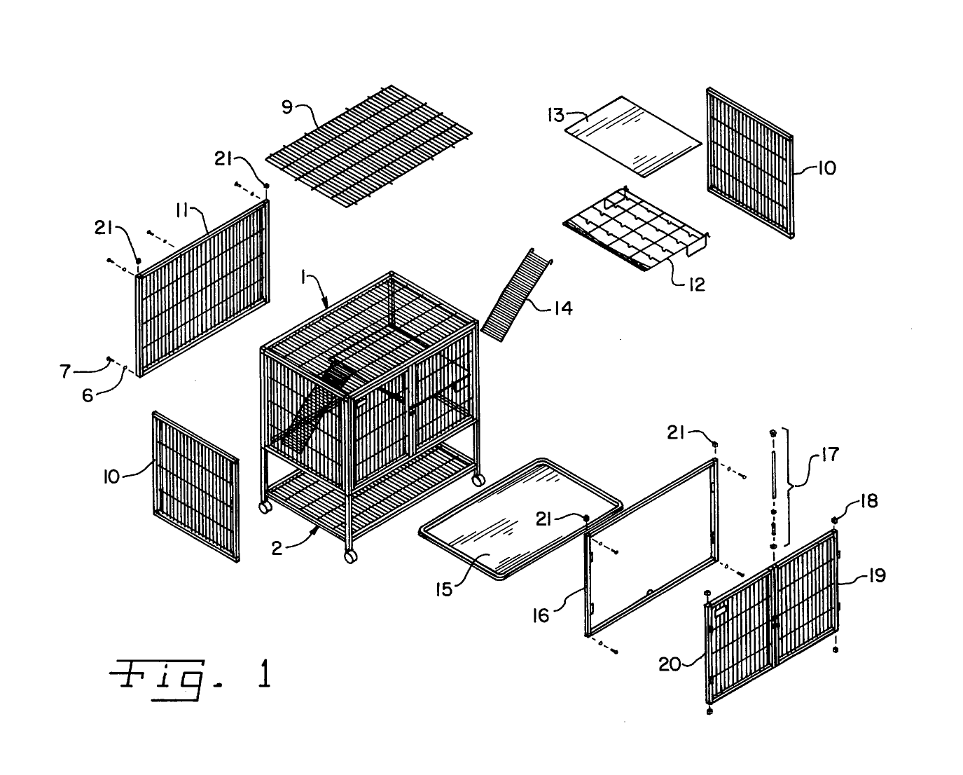

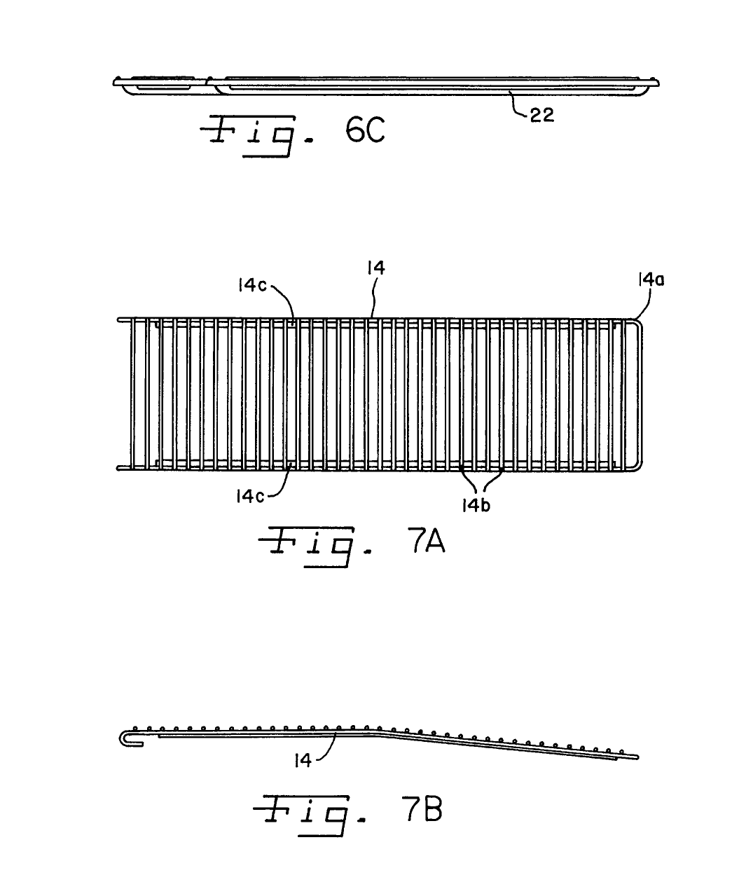

A first preferred embodiment of the present claimed technology, as shown in FIG. 1, presents an animal containment system 1 with a floor pan 15 disposed in a first plane, first and second end walls 10, each said end wall 10 oppositely disposed from each other, and a back wall 11. The front of the containment system 1 comprises a right door panel 19 and a left door panel 20. The top of the containment system 1 comprises a top panel 9 oppositely disposed from the floor pan 15. A shelf weldment 12 is disposed approximately midway between the floor pan 15 and top panel 9. The shelf weldment 12 may also be adjusted vertically as desired. A shelf pan 13 may rest directly upon the shelf weldment 12. A wire ladder 14, shown individually in FIGS. 7A and 7B, extends between the floor pan 15 and the shelf weldment 12. An animal, such as a ferret or other small animal, may choose to rest either on the lower floor pan 15 or upon the elevated shelf weldment 12. The maximum distance of a fall from a shelf weldment 12 is such that injury will likely not be sustained by the animal. Further, the wire ladder 14 is at an appropriate angle to promote climbing while decreasing the possibility of a fall by the animal. All panels and the floor pan 15 are connected to each other through conventional means, primarily screws, washers and threaded inserts.

The door panels 19-20 may be opened the full length and width of the containment system 1 to allow easy access to the containment system 1 for removal of the animal and maintenance of the sanitary condition of the containment system 1. The large opening space provided by the door panels 19-20 allows a pet owner to more thoroughly clean the containment system 1, as all areas of the containment system 1 become easily accessible. Further, the extra space will allow the pet owner to clean the containment system 1 in less time, as it will be easier to remove an animal and/or the lower floor pan 15 from the containment system 1. Feeding becomes easier, as the pet owner is less likely to spill food and/or water when transporting it either in or out of the containment system 1. The large opening also makes it more convenient to hang toys and re-arrange optional pet accessories, such as hammocks, litter boxes and feed bowls. All of these conveniences lead to a happier pet owner, which positively influences the human/animal bond.

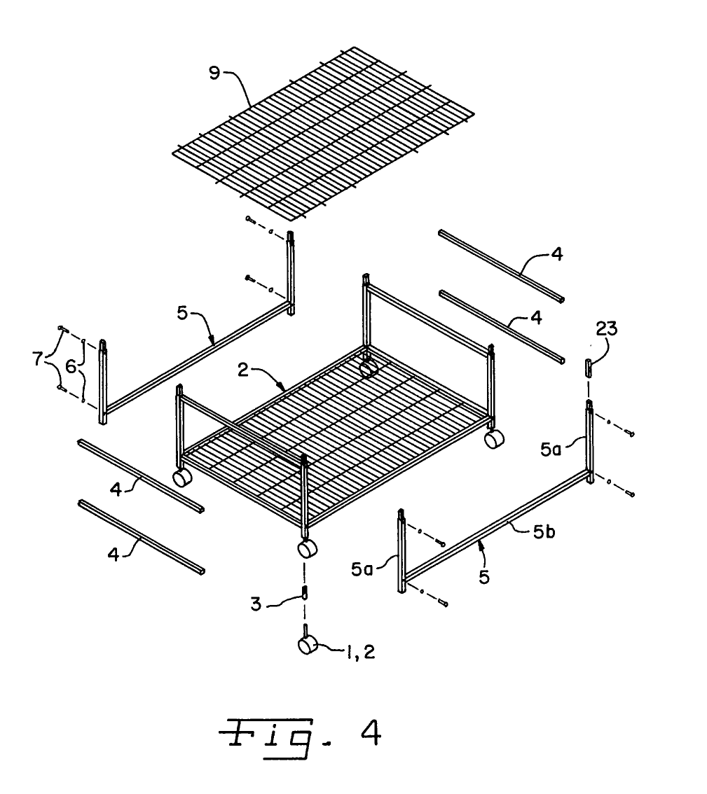

Further, the first preferred embodiment includes a wheel base assembly 2, as shown individually in FIG. 4, said wheel assembly 2 comprising a base panel 9, a base weldment 5 comprising vertical 5a and horizontal support tubes 5b, and preferably at least four (4) removable caster wheels 3. The wheel base assembly 2 allows the entire containment system 1 to be pushed easily from one location to another. The wheel base assembly 2 also makes it much easier to clean under the animal containment system 1. Further, the base panel 9 serves as a shelf to store food, medication, toys, and other animal accessories. The base panel 9 provides a convenient location next to the animal's home that the pet owner can use for storage. Wheels 3 can be removed when the containment system 1 is to be stacked or left in a fixed location for a period of time.

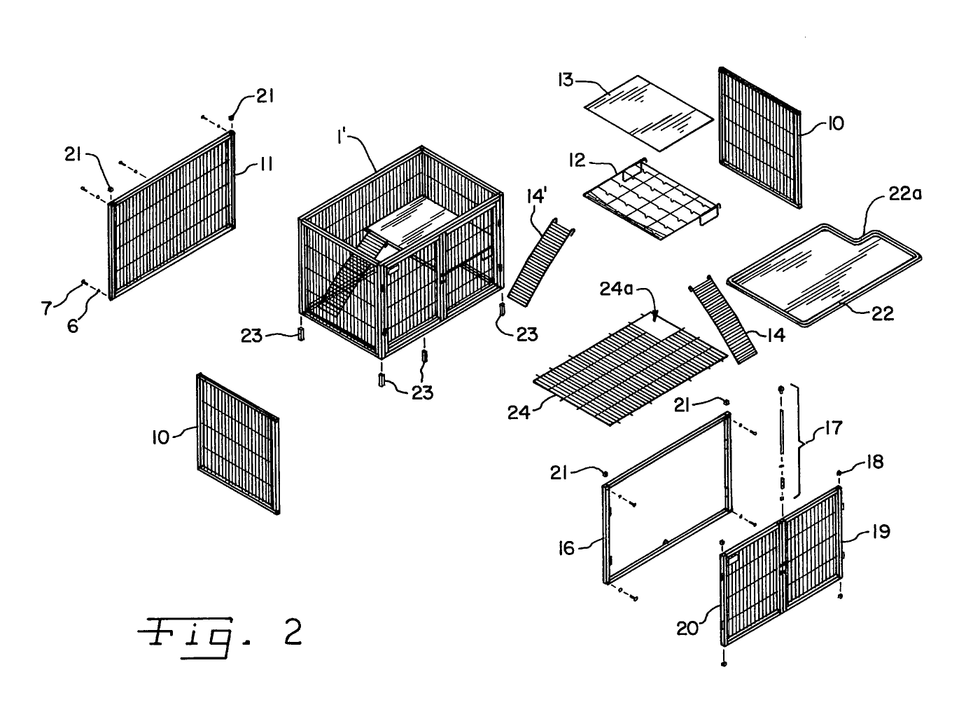

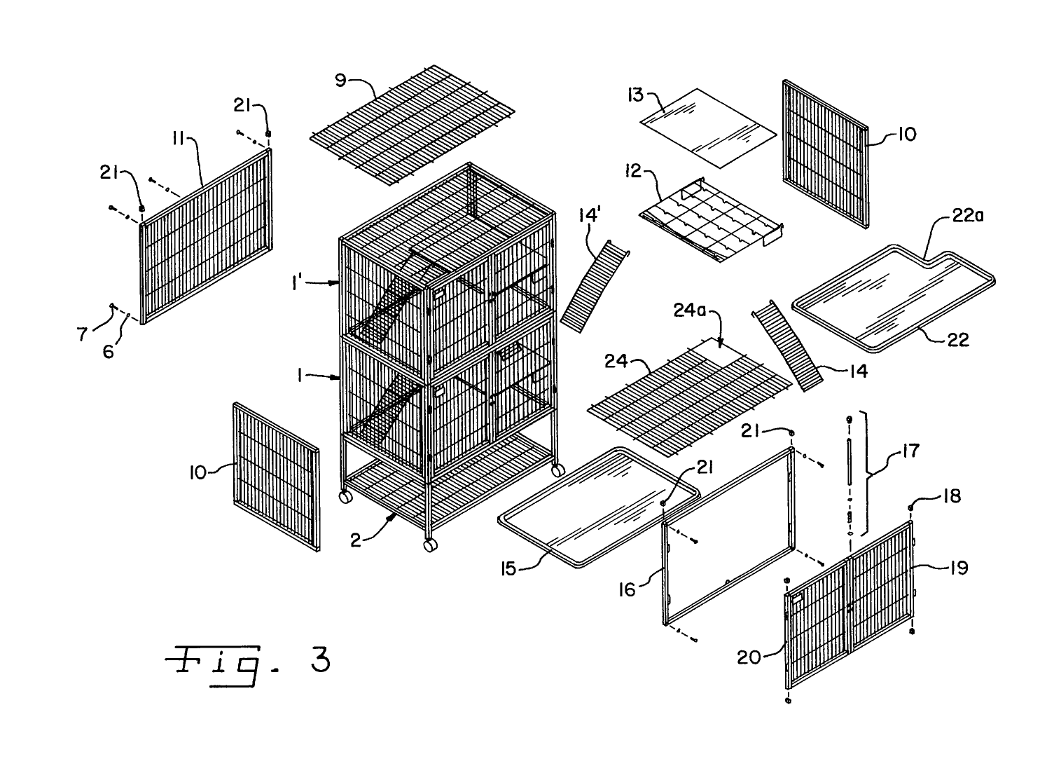

In an alternative embodiment as shown in FIGS. 2 and 3, a second animal containment system 1′ may be placed above the first animal containment system 1, with a second wire ladder 14′ extending between the shelf weldment 12 of the first containment system and the floor pan 22 of the second containment system 1′, through a cutout portion 24a in the top panel 24 of the first containment system 1 and a corresponding cutout portion 22a in the floor pan 22 of the second containment system 1′. A small animal inhabiting the first containment system 1 may utilize the ladder 14′ to access the upper second animal containment system 1′. Alternatively, the ladder 14′ may be swung upwards and attached via a hook to the bottom of the floor pan 22, thus blocking the cutout portion 24a, and preventing the animal from moving between containment systems 1-1′. The vacant level may then be cleaned without having to remove the animal completely from the containment system 1 and any concern that the animal might escape from the containment system 1 is eliminated. This feature can also be used to separate two animals from one another, which is often necessary when multiple animals are housed. This alternative embodiment may also employ the wheel base assembly 2 shown individually in FIG. 4. The containment system 1 may also be adapted to consist of three stacked units if two containment systems 1′ with cutout portions 24a are utilized.

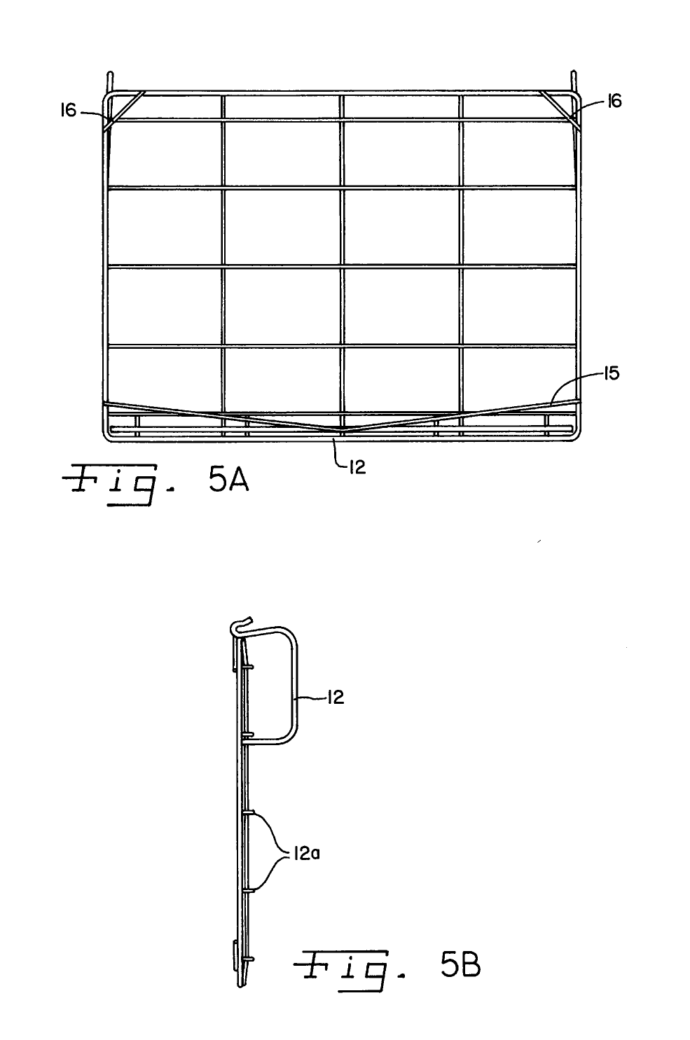

FIGS. 5A and 5B present the shelf weldment 12. The shelf pan 13, as shown in FIG. 1, is of a slightly smaller dimension than the shelf weldment 12, and may fit within, and be held in place by, front braces 15 and corner braces 16 of the shelf weldment 12. The shelf pan 13 is held in place so the animal cannot remove or dislodge it. At the same time, the pet owner can easily remove the shelf pan 13 for cleaning. Loops 12a are formed on the bottom side of the shelf weldment 12, from which toys, hammocks, and other accessories can hang. The shelf weldment 12 may be placed at different levels within the containment system 1 to accommodate the pet parent in terms of viewing the animal or providing more play area. By hanging a hammock from the bottom side of the shelf weldment 12, the distance of a possible fall by the animal is minimized.

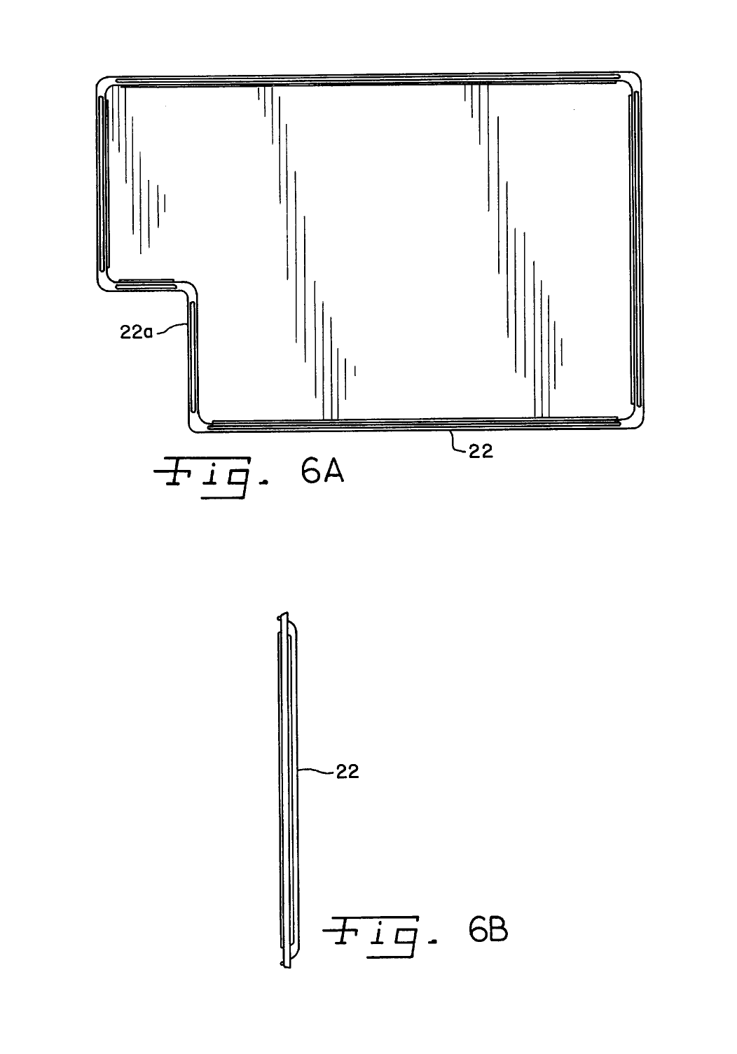

FIGS. 6A-6C present the floor pan 22, as shown in FIGS. 2 and 3, with cutout portion 22a. The periphery of the floor pan 22 is raised to form a “lip,” preventing food and animal excrement from going outside the containment system 1.

FIGS. 7A-7B present the wire ladder 14, as shown in FIGS. 1-3. The wire ladder 14 is constructed from a U-shaped wire 14a, operationally connected to opposing internal support members 14c. The rungs of the wire ladder 14 are a plurality of wire cross members 14b.

Preferably, the containment system 1 is of collapsible construction so that all walls and floors may be stored flat when not in use.

A preferred material from which this claimed technology may be constructed is steel.

While the claimed technology has been illustrated and described in detail in the drawings and foregoing description, the same is to be considered as illustrative and not restrictive in character, it being understood that only the preferred embodiment has been shown and described and that all changes and modifications that come within the spirit of the claimed technology are desired to be protected.

What is claimed is:

1. An animal containment system, comprising:
a floor pan disposed in a first plane;
first and second end walls, each said end wall oppositely disposed from each other and including a bottom edge and a top edge;
a back wall including a bottom edge and a top edge;
two doors, each including a bottom edge and a top edge, oppositely disposed from the back wall arranged to cover the open front portion of said animal containment system;
a top panel oppositely disposed from the floor pan;
a shelf disposed in between the floor pan and top panel;
a wire ladder extending between the floor pan and said shelf; and
a wheel base assembly, further comprising;
a base panel;
four support tubes; and
at least four removable caster wheels.

2. The animal containment system of claim 1, wherein each wall, the top panel, the doors and the base panel are of wire grill construction comprising a rectangular wire member defining the periphery of the panel, a first set of spaced parallel wires extending between opposite edges of the rectangular member, and a second set of spaced cross wires extending traversely across said first set of wires.

3. The animal containment system of claim 2, wherein a second animal containment system is placed above the first animal containment system, with a second wire ladder extending between the shelf of the first containment system and the floor pan of the second containment system, through cutout portions in the top panel of the first containment system and the floor pan of the second containment system.

4. The animal containment system of claim 2, in which the containment system is collapsible for storage.

5. The animal containment system of claim 3, in which both upper and lower containment systems are collapsible for storage.

6. A method of containing animals, the method comprising the steps of:
a) providing at least one animal containment system, the animal containment system comprising:
a floor pan disposed in a first plane;
first and second end walls, each said end wall oppositely disposed from each other and including a bottom edge and a top edge;
a back wall including a bottom edge and a top edge;
two doors, each including a bottom edge and a top edge, oppositely disposed from the back wall arranged to cover the open front portion of said animal containment system;
a top panel oppositely disposed from the floor pan;
a shelf disposed in between the floor pan and top panel;
a wire ladder extending between the floor pan and said shelf; and
a wheel base assembly, further comprising;
a base panel;
four support tubes; and
at least four removable caster wheels.
b) opening said doors;
c) inserting one or more animals into the animal containment system; and
d) closing said doors to secure the animal(s) within the animal containment system.

7. The method of containing animals as in claim 6, wherein each wall, the top panel, the doors and the base panel are of wire grill construction comprising a rectangular wire member defining the periphery of the panel, a first set of spaced parallel wires extending between opposite edges of the rectangular member, and a second set of spaced cross wires extending traversely across said first set of wires.

8. The method of containing animals as in claim 7, wherein a second animal containment system is placed above the first animal containment system, with a second wire ladder extending between the shelf of the first containment system and the floor pan of the second containment system, through cutout portions in the top panel of the first containment system and the floor pan of the second containment system.

9. The method of containing animals as in claim 7, in which the containment system is collapsible for storage.

10. The method of containing animals as in claim 8, in which both upper and lower containment systems are collapsible for storage.

11. An animal containment system comprising a plurality of animal cages arrayed vertically; each said animal cage comprising:
a floor pan disposed in a first plane;
first and second end walls, each said end wall oppositely disposed from each other and including a bottom edge and a top edge;
a back wall including a bottom edge and a top edge;
two doors, each including a bottom edge and a top edge, oppositely disposed from the back wall arranged to cover the open front portion of said animal containment system;
a top panel oppositely disposed from the floor pan;
a shelf disposed in between the floor pan and top panel;
a wire ladder extending between the floor pan and said shelf.

12. The animal containment system of claim 11, wherein a second wire ladder extends between the shelf of a first animal cage and the floor pan of a second animal cage, through cutout portions in the top panel of the first animal cage and the floor pan of the second animal cage.

13. The animal containment system of claim 11, further comprising a wheel base assembly located on the lowest animal cage in the vertical array, said wheel base assembly comprising a base panel, four support tubes and at least four removable caster wheels.

14. The animal containment system of claim 11, in which the containment system is collapsible for storage.
